(19) United States
(12) Patent Application Publication
(10) Pub. No.: US 2022/0121345 A1
(43) Pub. Date: Apr. 21, 2022

(54) SCREEN DISPLAY CONTROL METHOD, COMPUTER DEVICE, AND COMPUTER READABLE STORAGE MEDIUM

(71) Applicants: HKC Corporation Limited, Guangdong (CN); CHONGQING HKC OPTOELECTRONICS TECHNOLOGY CO., LTD., Chongqing (CN)

(72) Inventor: Zhongshan SHI, Chongqing (CN)

(73) Assignees: HKC Corporation Limited, Guangdong (CN); CHONGQING HKC OPTOELECTRONICS TECHNOLOGY CO., LTD., Chongqing (CN)

(21) Appl. No.: 17/298,255

(22) PCT Filed: May 7, 2020
(86) PCT No.: PCT/CN2020/088953

§ 371 Date: May 28, 2021

(30) Foreign Application Priority Data
May 7, 2019 (CN) 201910383605.6

(51) Int. Cl. G06F 3/04817; G06F 3/0484; G06F 3/0482; G06F 40/205; G06F 9/451

(52) U.S. Cl. CPC G06F 3/04817; G06F 3/0484; G06F 9/451; G06F 40/205; G06F 3/0482

(57) ABSTRACT

The present application relates to an screen display control method, a computer device, and a computer readable storage medium. The method comprises: according to a plurality of types of operation data and a plurality of corresponding types of alarm thresholds of each machine, acquiring icon position information of a faulty machine and fault information of the faulty machine, the fault information being used to represent the fault type of a fault that occurs in the faulty machine; according to the icon position information of the faulty machine, controlling an icon corresponding to the faulty machine on an interface to be displayed in accordance with a preset fault early warning state; and when the icon of the faulty machine is triggered, displaying the fault information of the faulty machine.

### CROSS REFERENCE TO RELATED APPLICATION

The present application claims priority to Chinese Patent Application No. 201910383605.6, entitled “IMAGE DISPLAY CONTROL METHOD, COMPUTER DEVICE, AND COMPUTER READABLE STORAGE MEDIUM”, filed on May 7, 2019, the content of which is incorporated herein by reference in its entirety.

### TECHNICAL FIELD

The present disclosure relates to the field of computer control, and more particularly, to a screen display control method, a computer device, and a computer readable storage medium.

### BACKGROUND

The statements here only provide background information related to this application, and do not necessarily constitute prior art.

In a production workshop, in order to facilitate management of each machine, an equipment fault management diagram is updated in real time on its supporting display system according to operating condition of each machine. For example, when a machine is faulty, an icon corresponding to the machine on the equipment fault management diagram is displayed in red. A staff can find the faulty machine by observing the red icon on the equipment fault management diagram, and then performs the next maintenance work on the faulty machine.

However, since the machine is composed of a plurality of sub-machines and there are many types of faults, after knowing that the machine is faulty through the equipment fault management diagram, it is necessary to shut down the machine and troubleshoot the fault points. The entire maintenance process has a long cycle and the equipment utilization is low, causing great economic losses.

### SUMMARY

Based on this, it is necessary to provide a screen display control method, a computer device, and a computer readable storage medium.

In an aspect, an embodiment of the present disclosure provides a screen display control method, which includes:

acquiring icon position information of a faulty machine and fault information of the faulty machine according to a plurality of types of operating data of each machine and a plurality of corresponding types of alarm thresholds, the fault information being configured to characterize a fault type of a fault that occurs in the faulty machine;

controlling an icon corresponding to the faulty machine on an interface to be displayed in accordance with a preset fault early warning state according to the icon position information of the faulty machine; and

displaying the fault information of the faulty machine when the icon of the faulty machine is triggered.

In one of the embodiments, the controlling an icon corresponding to the faulty machine on an interface to be displayed in accordance with a preset fault early warning state according to the icon position information of the faulty machine includes:

controlling the icon corresponding to the faulty machine on an interface to be displayed in red according to the icon position information of the faulty machine.

In one of the embodiments, the screen display control method further includes:

if it is determined according to the plurality of types of operating data of each machine and the plurality of corresponding types of alarm thresholds that the machine is not faulty, acquiring icon position information of the machine, and controlling the icon corresponding to the machine on the control interface to be displayed in green according to the icon position information.

In one of the embodiments, the screen display control method further includes:

if the associated icon on the interface is triggered, displaying a corresponding relationship table between display color of machine and state of machine.

In one of the embodiments, the operating data includes product dispatch data, and the screen display control method further includes:

obtaining icon position information of a machine of which automatic product dispatch is off according to the product dispatch data of each machine; and

displaying a product dispatch status indicator at a position corresponding to an icon of the machine of which automatic product dispatch is off according to the icon position information of the machine of which automatic product dispatch is off.

In one of the embodiments, the product dispatch status indicator includes a first product dispatch status indicator;

the step of obtaining an icon position information of a machine of which automatic product dispatch is off according to the product dispatch data of each machine includes:

if it is determined according to the product dispatch data of the machine that the machine is in a state that automatic product dispatch of a loader is off or automatic product dispatch of a common port is off, acquiring icon position information of the machine of which the automatic product dispatch of the loader is off or the machine of which the automatic product dispatch of the common port is off according to the product dispatch data;

the step of displaying a product dispatch status indicator at a position corresponding to an icon of the machine of which automatic product dispatch is off according to the icon position information of the machine of which automatic product dispatch is off includes:

displaying the first product dispatch status indicator at a position corresponding to an icon of the machine according to the icon position information of the machine of which the automatic product dispatch of the loader is off or the machine of which the automatic product dispatch of the common port is off.

In one of the embodiments, the product dispatch status indicator includes a second product dispatch status indicator;

the step of obtaining an icon position information of a machine of which automatic product dispatch is off according to the product dispatch data of each machine includes:

if it is determined according to the product dispatch data of the machine that the machine is in a state that automatic product dispatch of the unloader port is off, obtaining icon position information of the machine of which the automatic product dispatch of the unloader port is off according to the product dispatch data;

the step of displaying a product dispatch status indicator at a position corresponding to an icon of the machine of which automatic product dispatch is off according to the icon position information of the machine of which automatic product dispatch is off includes:

displaying the second product dispatch status indicator at a position corresponding to an icon of the machine according to the icon position information of the machine of which the automatic product dispatch of the unloader port is off.

In one of the embodiments, the step of obtaining the product dispatch data includes:

acquiring an automatic product dispatch instruction of a manufacturing execution system of a manufacturing enterprise; and

parsing the automatic product dispatch instruction to obtain the product dispatch data of each machine.

In one of the embodiments, the screen display control method further includes a step of: if it is determined according to the plurality of types of operating data of the machine that the machine is currently in a qualified batch sorting operation mode, displaying a qualified batch sorting indicator at a position corresponding to the icon of the machine.

In one of the embodiments, the operating data includes piece loading data of each chamber of the machine, and the screen display control method further includes:

when the machine is operating normally, if it is determined according to the piece loading data of each chamber of the machine that no piece is loaded within a preset time, displaying an abnormal idling indicator at a position corresponding to the icon of the machine.

In one of the embodiments, the screen display control method further includes:

if a query icon on the interface is triggered, popping up query menu options; wherein, the query menu options include one or more of an alarm list, equipment information, product in process list, workshop production management list, machine historical status information, idle equipment information, automatic product dispatch setting data of each machine, and machine product dispatch historical data.

In one of the embodiments, the screen display control method further includes:

obtaining an inventory quantity of a storage turnover warehouse according to the plurality of types of operating data of the machine; and

if the inventory quantity is greater than a preset full warehouse threshold, displaying a warehouse explosion early warning indicator.

In one of the embodiments, the screen display control method further includes:

obtaining an inventory quantity of a storage turnover warehouse according to the plurality of types of operating data of the machine; and

if the inventory quantity is less than a preset full warehouse threshold, displaying a storage space remaining indicator.

In one of the embodiments, the screen display control method further includes:

obtaining an inventory quantity of a storage turnover warehouse according to the plurality of types of operating data of the machine; and

if the inventory quantity is greater than a preset shutdown threshold, displaying a warehouse shutdown indicator.

In one of the embodiments, the obtaining an inventory quantity of a storage turnover warehouse according to the plurality of types of operating data of the machine includes:

acquiring an order quantity allocated to the machine through an order production system;

acquiring a quantity of pieces that have already loaded in the machine; and

obtaining the inventory quantity of the current storage turnover warehouse according to a difference between the allocated order quantity and the quantity of pieces already loaded,

In one of the embodiments, the screen display control method further includes:

acquiring photoresist data uploaded by each sensor on the production line, if it is determined according to the photoresist data that a photoresist of a corresponding machine is insufficient, displaying a photoresist insufficient indicator at a position corresponding to the icon of the machine.

In another aspect, an embodiment of the present disclosure provides a computer device including a memory and a processor, the memory has a computer program stored therein, and when the computer program is executed by the processor, the following steps are implemented:

acquiring icon position information of a faulty machine and fault information of the faulty machine according to a plurality types of operating data of each machine and a plurality of corresponding types of alarm thresholds, the fault information being configured to characterize a fault type of a fault that occurs in the faulty machine;

controlling an icon corresponding to the faulty machine on an interface to be displayed in accordance with a preset fault early warning state according to the icon position information of the faulty machine; and

displaying the fault information of the faulty machine when the icon of the faulty machine is triggered.

In an aspect, an embodiment of the present disclosure provides a computer readable storage medium on which a computer program is stored, and when the computer program is executed by a processor, the following steps are implemented:

acquiring icon position information of a faulty machine and fault information of the faulty machine according to a plurality types of operating data of each machine and a plurality of corresponding types of alarm thresholds, the fault information being configured to characterize a fault type of a fault that occurs in the faulty machine;

controlling an icon corresponding to the faulty machine on an interface to be displayed in accordance with a preset fault early warning state according to the icon position information of the faulty machine; and

displaying the fault information of the faulty machine when the icon of the faulty machine is triggered.

The one or more embodiments provided by the present disclosure have at least the following advantages: in the screen display control method, through dividing a plurality of alarm thresholds by the types, different types of data of a machine are compared with the corresponding types of alarm thresholds, such that whether each type of data is normal can be known. If one type of data amongst the plurality of types of data is abnormal, it indicates that the machine is in a faulty operation state, and a warning is required, the icon of the machine on the interface is controlled to be displayed according to the preset fault early warning state. For example, it can be in a form such as controlling the icon to be displayed in red, so as to play a role of reminding and warning. In order to facilitate the staff to quickly understand the specific type of fault of the machine, by triggering the icon of the machine displayed in the fault early warning state, the fault information of the faulty machine can be correspondingly displayed on the interface, such that the staff can quickly understand the specific fault cause and fault type of the faulty machine, so as to provide a data basis for subsequent maintenance, shorten the maintenance cycle of the machine, increase the machine utilization, and further improve the production efficiency.

### BRIEF DESCRIPTION OF THE DRAWINGS

FIG. 1 is a schematic flowchart of a screen display control method in an embodiment.

FIG. 2 is a schematic flowchart of a screen display control method in another embodiment.

FIG. 3 is a schematic flowchart of the steps of obtaining icon position information of a machine of which automatic product dispatch is off according to the product dispatch data of each machine and a schematic flowchart of displaying a product dispatch status indicator at a position corresponding to an icon of the machine of which automatic product dispatch is off according to the icon position information of the machine of which automatic product dispatch is off in an embodiment.

FIG. 4 is a schematic flowchart of the steps of obtaining icon position information of a machine of which automatic product dispatch is off according to the product dispatch data of each machine and a schematic flowchart of displaying a product dispatch status indicator at a position corresponding to an icon of the machine of which automatic product dispatch is off according to the icon position information of the machine of which automatic product dispatch is off in another embodiment.

FIG. 5 is a schematic diagram of a step of obtaining the product dispatch data in an embodiment.

FIG. 6 is a schematic flowchart of a screen display control method in yet another embodiment.

FIG. 7 is a schematic structure diagram of a screen display control module in an embodiment.

FIG. 8 is an internal structure diagram of a computer device in an embodiment.

### DETAILED DESCRIPTION

In order to facilitate the understanding of the present disclosure, the present disclosure will be described more fully hereinafter with reference to the related accompanying drawings. Preferable embodiments of the present disclosure are presented in the accompanying drawings. However, the present disclosure may be embodied in many different forms and is not limited to the embodiments described herein. Rather, these embodiments are provided so that the understanding of the content of the present disclosure will be more thorough.

It should be noted that when an element is considered being “connected” to another element, it is either directly connected to an element or indirectly connected to an element with a mediating element.

All technical and scientific terms used herein have the same meaning as commonly understood by one of ordinary skill in the art to which this disclosure applies, unless otherwise defined. The terms used in the specification of present disclosure herein are for the purpose of describing specific embodiments only and are not intended to limit the present disclosure. The term “and/or” used herein includes any and all combinations of one or more of the associated listed items.

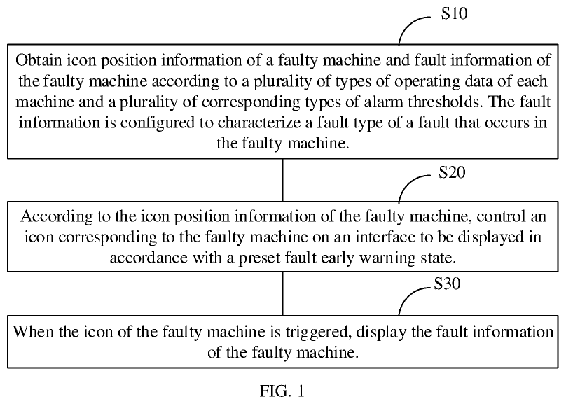

In an aspect, an embodiment of the present disclosure provides a screen display control method, as shown in FIG. 1, which includes:

S10: obtain icon position information of a faulty machine and fault information of the faulty machine according to a plurality of types of operating data of each machine and a plurality of corresponding types of alarm thresholds. The fault information is configured to characterize a fault type of a fault that occurs in the faulty machine;

S20: according to the icon position information of the faulty machine, control an icon corresponding to the faulty machine on an interface to be displayed in accordance with a preset fault early warning state; and

S30: when the icon of the faulty machine is triggered, display the fault information of the faulty machine.

The plurality of types of operating data of a machine may include data related to the machine's operation, such as a speed, piece loading data, and automatic product dispatch data, and the like of the machine. The plurality of types of operating data of the machine can be obtained through approaches such as an order production system, a Manufacturing Execution System (MES) of a manufacturing enterprise, and various sensors installed on the machine. The plurality of types of alarm thresholds are values used to be compared with corresponding types of data to determine whether the machine is faulty. For example, for the piece loading data, its corresponding alarm threshold is a preset time, if no piece is loaded within the preset time when the machine is dispatching products normally, it can be determined that a fault of piece being stuck occurs in the machine. The faulty machine refers a machine that has at least one type of operating data that is abnormal. Whether the operating data is abnormal can be obtained by comparing the operating data with the alarm threshold of the corresponding type. The icon position information of the faulty machine may include coordinates of the icon of the faulty machine in an interface coordinate system. The fault information may include abnormal operating data, icon position information of the faulty machine, serial number of the faulty machine, and the like. The icon is displayed in accordance with the preset fault early warning state may be that, the icon is displayed in red for early warning or flashing early warning, and the like. Common reminding means that can realize the fault early warning for abnormality are all within the protection scope of the embodiments of the present disclosure.

Operating data of one or more sub-machines of the machine is acquired, the plurality of types of operating data of the machine is compare with the plurality of corresponding types of alarm thresholds to determine whether each type of data is abnormal. If it is determined that at least one type of operating data is abnormal, then it indicates that the machine is faulty. At this time, according to the icon position information of the faulty machine acquired from the Manufacturing Execution System of the manufacturing enterprise or the operating data, the icon of the machine at the corresponding position on the interface can be controlled to be displayed in accordance with the preset fault early warning state, so as to remind a staff that the machine is faulty. In order to facilitate the staff to quickly learn a fault cause of the machine after discovering that the machine is faulty, when at least one type of operating data is determined to be abnormal, fault information of the faulty machine can further be obtained, and the fault information of the faulty machine can be stored and be associated with the corresponding icon position information of the faulty machine. When the icon of the faulty machine is triggered, the fault information of the faulty machine is quickly displayed. By associating the trigger action of the icon of the faulty machine and the fault information of the faulty machine, when the machine is faulty, the staff can quickly learn the fault cause of the machine and formulate the corresponding maintenance plan, so as to shorten maintenance cycle, improve equipment utilization, and improve production efficiency. There are many ways to trigger the icon of the faulty machine. For example, one can select the icon of the faulty machine with a mouse and click a right button of the mouse.

In one of the embodiments, after acquiring the icon position information of the faulty machine according to the plurality of types of operating data of each machine and the plurality of corresponding types of alarm thresholds, the corresponding icon of the faulty machine on the interface is controlled to be displayed in red according to the icon position information of the faulty machine. If it is determined according to the plurality of types of operating data of each machine and the plurality of corresponding types of alarm thresholds that the machine is not faulty, then icon position information of the machine is acquired, and the icon corresponding to the machine on the control interface is controlled to be displayed in green according to the icon position information.

In one of the embodiments, the screen display control method further includes:

if the associated icon on the interface is triggered, display a corresponding relationship table between display color of machine and state of machine. For example, the user can click the associated icon on the interface to trigger the icon. After the trigger, red displayed on the interface represent that the machine is faulty and green displayed on the interface represent that the machine is operating normally. The use of the associating reminding function can help the staff quickly grasp the meaning of the information represented on the equipment fault management diagram, and can more quickly join in the monitoring and inspection on the operating equipment of the machine.

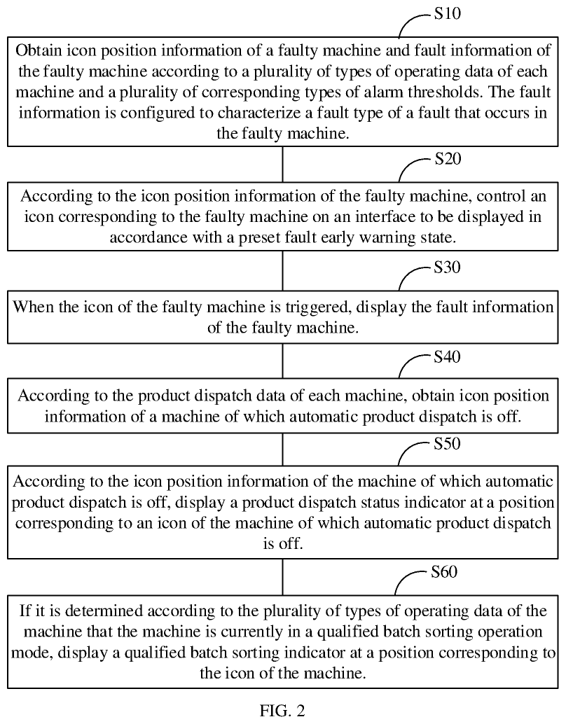

In one of the embodiments, as shown in FIG. 2, the operating data includes product dispatch data, and the screen display control method further includes:

S40: according to the product dispatch data of each machine, obtain icon position information of a machine of which automatic product dispatch is off; and

S50: according to the icon position information of the machine of which automatic product dispatch is off, display a product dispatch status indicator at a position corresponding to an icon of the machine of which automatic product dispatch is off.

In order to effectively help the staff to distinguish the operating conditions of the automatic dispatch of products by each machine, the icon position information of the machine of which automatic product dispatch is off can be obtained according to the product dispatch data in the operating data, and the product dispatch status indicator can be displayed near the position of the icon. When the staff sees the product dispatch status indicator on the machine, they can know the state of the automatic dispatch of products by the machine. Obtaining the icon position information of the machine of which automatic product dispatch is off can be, according to an identification information such as a serial number of the machine in the product dispatch data and then according to the serial number of the machine, obtaining the icon position information of the machine with this serial number. The correspondence relationship between serial numbers and icon position information can be a pre-stored relationship table, and the icon position information corresponding to the serial number of the machine can be obtained by looking up the table. The product dispatch status indicator is adapted to indicate that the corresponding machine is currently in a state that the automatic product dispatch is off. The specific form of the product dispatch status indicator can be displaying a defined letter on the interface for reminding. It can also be highlighting at the corresponding position of the icon of the machine for reminding.

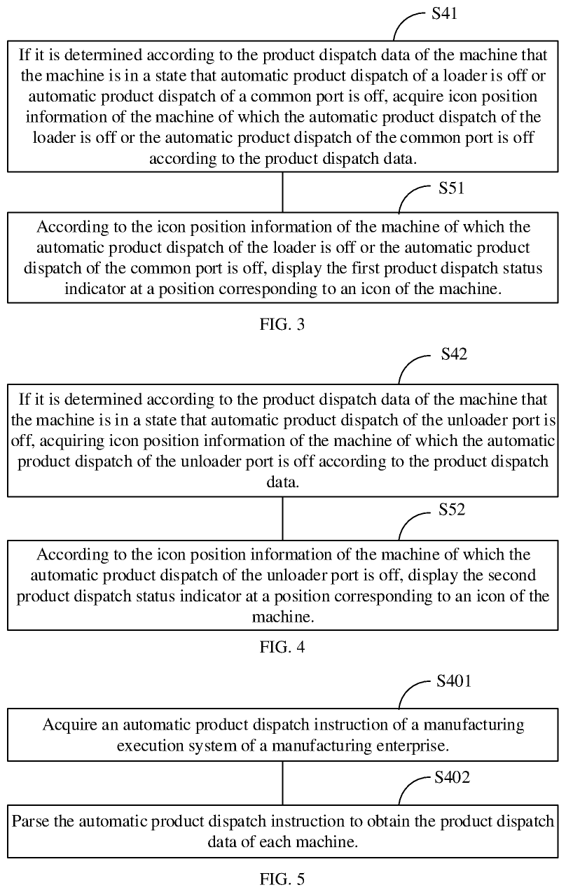

In one of the embodiments, as shown in FIG. 3, the product dispatch status indicator includes a first product dispatch status indicator;

the step of S40: obtaining icon position information of a machine of which automatic product dispatch is off according to the product dispatch data of each machine includes:

S41: if it is determined according to the product dispatch data of the machine that the machine is in a state that automatic product dispatch of a loader is off or automatic product dispatch of a common port is off, acquire icon position information of the machine of which the automatic product dispatch of the loader is off or the automatic product dispatch of the common port is off according to the product dispatch data;

the step of S50: displaying a product dispatch status indicator at a position corresponding to an icon of the machine of which automatic product dispatch is off according to the icon position information of the machine of which automatic product dispatch is off includes:

S51: according to the icon position information of the machine of which the automatic product dispatch of the loader is off or the automatic product dispatch of the common port is off, display the first product dispatch status indicator at a position corresponding to an icon of the machine.

The product dispatch data can be acquired from the Manufacturing Execution System of the manufacturing enterprise. Specifically, when it is determined according to the product dispatch data of the machine that the automatic product dispatch of the loader of the current machine is off, or that the automatic product dispatch of the common port is finished, the icon position information of the machine is obtained, and the first product dispatch status indicator is displayed at the corresponding position of its icon. The first product dispatch status indicator may be a predefined letter, such as a letter “L” or the like. When the staff observes that the letter “L” is displayed around the machine, they can know that currently the automatic product dispatch of the loader or the common port of this machine is off. The staff is helped to quickly understand the real-time setting state of automatic dispatch of products by each equipment.

In one of the embodiments, as shown in FIG. 4, the product dispatch status indicator includes a second product dispatch status indicator;

the step of S40: obtaining icon position information of a machine of which automatic product dispatch is off according to the product dispatch data of each machine includes:

S42: if it is determined according to the product dispatch data of the machine that the machine is in a state that automatic product dispatch of the unloader port is off, acquiring icon position information of the machine of which the automatic product dispatch of the unloader port is off according to the product dispatch data;

the step of S50: displaying a product dispatch status indicator at a position corresponding to an icon of the machine of which automatic product dispatch is off according to the icon position information of the machine of which automatic product dispatch is off includes:

S52: according to the icon position information of the machine of which the automatic product dispatch of the unloader port is off, display the second product dispatch status indicator at a position corresponding to an icon of the machine.

Same as above, in order to get a better and intuitive understanding of the real-time state of the automatic dispatch of product by each equipment, when it is determined according to the product dispatch data of the machine that the automatic product dispatch of the unloader port of the machine is off, the icon position information of the machine is acquired, and the second product dispatch status indicator is displayed near the icon. The second product dispatch status indicator may be a predefined letter, such as “U” or the like. It can also be highlighted in an agreed color near the icon of the machine.

In one of the embodiments, as shown in FIG. 5, the step of obtaining the product dispatch data includes:

S401: acquire an automatic product dispatch instruction of a manufacturing execution system of a manufacturing enterprise; and

S402: parse the automatic product dispatch instruction to obtain the product dispatch data of each machine.

When the staff operates an automatic product dispatch switch of the machine through the Manufacturing Execution System of the manufacturing enterprise, that is, when the staff issues the corresponding automatic product dispatch instruction through the Manufacturing Execution System of the manufacturing enterprise (the corresponding automatic product dispatch instruction can be generated by triggering the automatic product dispatch switch), the product dispatch data of the machine can be obtained by acquiring the automatic product dispatch instruction and parsing the instruction. There is a corresponding relationship between the automatic product dispatch instruction and the machine. For example, if the target machine of the automatic product dispatch instruction issued by the Manufacturing Execution System of the manufacturing enterprise is No. 1 machine, then the product dispatch data of the No. 1 machine can be obtained from parsing the automatic product dispatch instruction. Therefore, the product dispatch data is automatic product dispatch setting parameters issued to the machine.

In one of the embodiments, as shown in FIG. 2, the screen display control method further includes steps:

S60: if it is determined according to the plurality of types of operating data of the machine that the machine is currently in a qualified batch sorting operation mode, display a qualified batch sorting indicator at a position corresponding to the icon of the machine.

The qualified batch distribution operation mode means that the machine is configured to cooperate with other machines to realize the sorting and dispatching of qualified and unqualified products. When it is determined according to the operating data of the machine that the machine is currently in the qualified batch sorting operation mode, then the qualified batch sorting indicator is displayed at the corresponding position of the icon of the machine, for example, it can be a defined letter “C”.

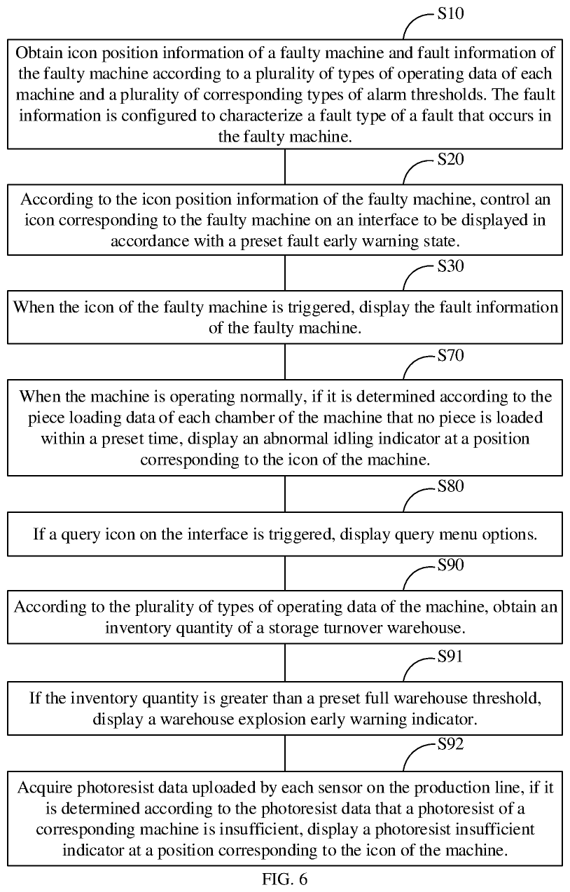

In one of the embodiments, as shown in FIG. 6, the operating data includes piece loading data of each chamber of the machine, and the screen display control method further includes:

S70: when the machine is operating normally, if it is determined according to the piece loading data of each chamber of the machine that no piece is loaded within a preset time, display an abnormal idling indicator at a position corresponding to the icon of the machine.

When the machine is dispatching products normally, in order to prevent missing inspection on faults caused by a piece abnormally stuck or other abnormal reasons, whether no piece is loaded within the predetermined time can be determined. If no piece is loaded continuously within the predetermined time (such as 20 min), it can be determined that piece being abnormally stuck or other abnormality occurs in one or more sub-machines of the machine, and the abnormal idling indicator is displayed near the position of the icon of the machine (for example, a letter “D” can be displayed for reminding). So as to remind the staff that currently the machine is not dispatching products normally. The piece loading data can be acquired through photoelectric counting sensors installed on the production line. Whether the machine is in a normal product dispatch mode can be obtained by parsing an operating instruction assigned to the machine from the Manufacturing Execution System of the manufacturing enterprise.

In one of the embodiments, as shown in FIG. 6, the screen display control method further includes:

S80: if a query icon on the interface is triggered, display query menu options; the query menu options include one or more of: an alarm list, equipment information, product in process list, workshop production management list, machine historical status information, idle equipment information, automatic product dispatch setting data of each machine, and machine product dispatch historical data.

To further facilitate the staff to quickly acquire important information of the machine to understand the operating state of each machine. A query icon is provided on the interface. When the query icon is triggered, query menu options are displayed on the interface; the options include one or more of: alarm list, equipment information, product in process list, workshop production management list, machine historical status information, idle equipment information, automatic product dispatch setting data of each machine and machine product dispatch historical data. The specific option settings can be set according to actual needs. The alarm list (Alarm List) is used to query the historical alarm information of the machine. The equipment information (Equipment Information) is used to query current state of the machine (operating, idling, shutdown, maintenance, and the like). The product in process list (In Process List) is used to query the list details of the pieces that have been loaded and executed in the current machine. The workshop production management list (WIP List) is used to query the list details of those currently waiting to be loaded in the machine and to be executed. The machine historical status information (Equipment Status History) is used to query the historical state and remark information of the machine. The idle equipment information is used to query the information of existing masks on the exposing and developing machine. The automatic product dispatch setting data of each machine is used to query the setting parameters of the current automatic product dispatch order port of each machine, that is, the aforementioned product dispatch data. The machine product dispatch historical data is used to query the product dispatch data of the past period of time (can be the past two days).

In one of the embodiments, as shown in FIG. 6, the screen display control method further includes:

S90: according to the plurality of types of operating data of the machine, obtain an inventory quantity of a storage turnover warehouse; and

S91: if the inventory quantity is greater than a preset full warehouse threshold, display a warehouse explosion early warning indicator.

In order to avoid the accumulation of products to be loaded on the machine in the storage turnover warehouse near the loading port, the inventory quantity of the storage turnover warehouse can be obtained according to the operating data. If the inventory quantity is greater than the preset full warehouse threshold, the warehouse explosion early warning indicator is displayed, for example, a pink icon of the storage turnover warehouse can be displayed for warning. It can also be other early warning indicators. The implementation of obtaining an inventory quantity of a storage turnover warehouse according to the plurality of types of operating data of the machine can be, acquiring an order quantity allocated to the machine through an order production system, and then acquiring a quantity of pieces that have already been loaded in the machine, and obtaining the inventory quantity of the current storage turnover warehouse according to a difference between the allocated order quantity and the quantity of pieces already loaded, For the warehouse explosion early warning, a threshold can also be set for the storage turnover warehouse of each machine. If the order quantity acquired from the order production system is greater than the threshold, then it is considered that the turnover warehouse is about to warehouse explode, the warehouse explosion early warning indicator is displayed near the position of the icon of the machine.

In one of the embodiments, if the inventory quantity is less than the preset full warehouse threshold, a storage space remaining indicator is displayed. It reminds the user that there is still space remained in the current storage turnover warehouse that can store product. The storage space remaining indicator may be a greenish icon of the storage turnover warehouse, or the like.

In one of the embodiments, if the inventory quantity is greater than a preset shutdown threshold, a warehouse shutdown indicator is displayed. So as to remind the staff that for the inventory level of the current storage turnover warehouse, no more products can be transferred to this warehouse, and deployment is needed to transfer the product to other places. The preset shutdown threshold may be set according to the actual storage capacity of the turnover warehouse.

In one of the embodiments, as shown in FIG. 6, the screen display control method further includes:

S92: acquire photoresist data uploaded by each sensor on the production line, if it is determined according to the photoresist data that a photoresist of a corresponding machine is insufficient, display a photoresist insufficient indicator at a position corresponding to the icon of the machine.

The corresponding collection of sensing data is performed according to the photoresist required in the photolithographic process. If is determined according to the acquired photoresist data that the photoresist on the corresponding machine is insufficient, the photoresist insufficient indicator is displayed at the corresponding position of the icon of the machine to remind the staff to replace this part of photoresist, so as to avoid the reduced product qualification rate or the abnormal shutdown of the machine due to insufficient photoresist in the production process.

The one or more embodiments provided by the present disclosure have at least the following advantages: in the screen display control method, through dividing a plurality of alarm thresholds by the types, different types of data of a machine are compared with the corresponding types of alarm thresholds, such that whether each type of data is normal can be known. If one type of data amongst the plurality of types of data is abnormal, it indicates that the machine is in a faulty operation state, and a warning is required, the icon of the machine on the interface is controlled to be displayed according to the preset fault early warning state. For example, it can be in a form such as controlling the icon to be displayed in red, so as to play a role of reminding and warning. In order to facilitate the staff to quickly understand the specific type of fault of the machine, by triggering the icon of the machine displayed in the fault early warning state, the fault information of the faulty machine can be correspondingly displayed on the interface, such that the staff can quickly understand the specific fault cause and fault type of the faulty machine, so as to provide a data basis for subsequent maintenance, shorten the maintenance cycle of the machine, increase the machine utilization, and further improve the production efficiency.

It should be understood that although the various steps in the flowchart of FIGS. 1-6 are sequentially displayed as indicated by the arrows, these steps are not necessarily performed in the order indicated by the arrows. Unless explicitly stated herein, the execution of these steps is not strictly limited in order, and these steps may be performed in other orders. Moreover, at least part of the steps in FIGS. 1-6 may comprise a plurality of sub-steps or phases, which are not necessary to be performed simultaneously, but may be performed at different times, and for the performing order thereof, it is not necessary to be performed sequentially, but may be performed by turns or alternately with other steps or sub-steps of other steps or at least part of the phases.

A screen display control device, as shown in FIG. 7, includes:

An information acquisition unit 1, configured to obtain icon position information of a faulty machine and fault information of the faulty machine according to a plurality of types of operating data of each machine and a plurality of corresponding types of alarm thresholds. The fault information is configured to characterize a fault type of a fault that occurs in the faulty machine;

a fault early warning and control unit 2, configured to control an icon corresponding to the faulty machine on an interface to be displayed in accordance with a preset fault early warning state according to the icon position information of the faulty machine; and

a fault information display unit, configured to display the fault information of the faulty machine when the icon of the faulty machine is triggered.

For specific limitations and implementing process of the screen display control device, reference may be made to the above limitations on the screen display control method, which will not be repeated here. Each of the above units in the screen display control device may be implemented in whole or in part by software, hardware and combinations thereof. Each of the above units may be embedded in or independent of a processor in a computer device in hardware forms, or may be stored in a memory of the computer device in software forms, so that the processor can invoke and execute the operations corresponding to each of the above units.

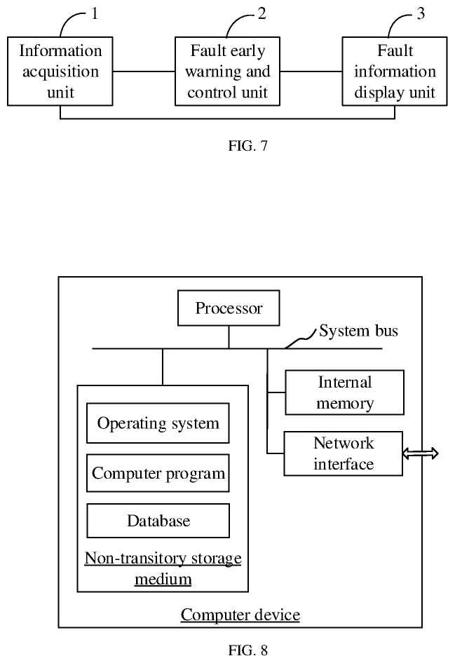

In an embodiment, a computer device is provided, the computer device may be a server, and an internal structure diagram thereof may be as shown in FIG. 8. The computer device includes a processor, a memory, a network interface, and a database connected by a system bus. The processor of the computer device is configured to provide computing and control capabilities. The memory of the computer device includes a non-transitory storage medium and an internal memory. The non-volatile storage medium is stored with an operating system, computer programs and a data base. The internal memory provides a running environment for the operating system and the computer program in the non-transitory storage medium. The database of the computer device is configured to store operating data. The network interface of the computer device is configured to communicate with an external terminal via a network connection. When the computer program is executed by the processor, the screen display method is implemented.

It will be understood by those skilled in the art that the structure shown in FIG. 8 is only a block diagram of a part of the structure related to the solution of the present disclosure, and does not constitute a limitation of the computer device to which the solution of the present disclosure is applied. The specific computer device may include more or fewer components than those shown in the figure, or combine some components, or have different component arrangements.

A computer device including a memory and a processor is provided. The memory is stored with a computer program, and when the processor executes the computer program, the steps below will be implemented:

S10: obtain icon position information of a faulty machine and fault information of the faulty machine according to a plurality of types of operating data of each machine and a plurality of corresponding types of alarm thresholds. The fault information is configured to characterize a fault type of a fault that occurs in the faulty machine;

S20: According to the icon position information of the faulty machine, control an icon corresponding to the faulty machine on an interface to be displayed in accordance with a preset fault early warning state; and

S30: when the icon of the faulty machine is triggered, display the fault information of the faulty machine.

A computer-readable storage medium stored with a computer program is provided. The steps below will be implemented when a processor executes the computer program:

S10: obtain icon position information of a faulty machine and fault information of the faulty machine according to a plurality of types of operating data of each machine and a plurality of corresponding types of alarm thresholds. The fault information is configured to characterize a fault type of a fault that occurs in the faulty machine;

S20: according to the icon position information of the faulty machine, control an icon corresponding to the faulty machine on an interface to be displayed in accordance with a preset fault early warning state; and

S30: when the icon of the faulty machine is triggered, display the fault information of the faulty machine.

It can be understood by those skilled in the art that all or part of the processes in the methods of the above embodiments may be implemented by instructing related hardwares through computer programs. The computer programs may be stored in a non-transitory computer readable storage medium. When the computer programs are executed, the processes of the embodiments of the above methods can be included. Any reference to the memory, storage, database or other media used in various embodiments provided in the present disclosure may include non-transitory and/or transitory memory. The non-transitory memory may include a Read Only Memory (ROM), a Programmable ROM (PROM), an Electrically Programmable ROM (EPROM), an Electrically Erasable Programmable ROM (EEPROM) or a flash memory. The transitory memory may include a Random Access Memory (RAM) or an external cache memory. As illustration rather than limitation, the RAM is available in a variety of forms, such as a Static RAM (SRAM), a Dynamic RAM (DRAM), a Synchronous DRAM (SDRAM), a Dual Data Rate SDRAM (DDRSDRAM), an Enhanced SDRAM (ESDRAM), a Synchlink DRAM (SLDRAM), a Rambus Direct RAM (RDRAM), a Direct Rambus Dynamic RAM (DRDRAM), a Rambus Dynamic RAM (RDRAM), and the like.

The technical features of the above-described embodiments can be combined arbitrarily. To simplify the description, not all possible combinations of the technical features in the above embodiments are described. However, all of the combinations of these technical features should be considered as within the scope of this disclosure, as long as such combinations do not contradict with each other.

The above embodiments merely illustrate several embodiments of the present disclosure, and the description thereof is specific and detailed, but it shall not be constructed as limiting the scope of this application. It should be noted that for those of ordinary skill in the art, without departing from the concept of this disclosure, several modifications and improvements can be made, which are all within the protection scope of the present disclosure. Therefore, the protection scope of the present disclosure shall be subject to the appended claims.

1. A screen display control method, comprising:
obtaining icon position information of a faulty machine and fault information of the faulty machine according to a plurality of types of operating data of each machine and a plurality of corresponding types of alarm thresholds, the fault information being configured to characterize a fault type of a fault that occurs in the faulty machine;
controlling an icon corresponding to the faulty machine on an interface to be displayed in accordance with a preset fault early warning state according to the icon position information of the faulty machine; and
displaying the fault information of the faulty machine when the icon of the faulty machine is triggered.

2. The screen display control method according to claim 1, wherein the controlling an icon corresponding to the faulty machine on an interface to be displayed in accordance with a preset fault early warning state according to the icon position information of the faulty machine comprises:
controlling the icon corresponding to the faulty machine on an interface to be displayed in red according to the icon position information of the faulty machine.

3. The screen display control method of claim 1, further comprising:
if it is determined according to the plurality of types of operating data of each machine and the plurality of corresponding types of alarm thresholds that the machine is not faulty, acquiring icon position information of the machine, and controlling the icon corresponding to the machine on the control interface to be displayed in green according to the icon position information.

4. The screen display control method of claim 1, further comprising:
if the associated icon on the interface is triggered, displaying a corresponding relationship table between display color of machine and state of machine.

5. The screen display control method of claim 1, wherein the operating data comprises product dispatch data, and the screen display control method further comprises:
obtaining icon position information of a machine of which automatic product dispatch is off according to the product dispatch data of each machine; and
displaying a product dispatch status indicator at a position corresponding to an icon of the machine of which automatic product dispatch is off according to the icon position information of the machine of which automatic product dispatch is off.

6. The screen display control method of claim 5, wherein the product dispatch status indicator comprises a first product dispatch status indicator;
the step of obtaining an icon position information of a machine of which automatic product dispatch is off according to the product dispatch data of each machine comprises:
if it is determined according to the product dispatch data of the machine that the machine is in a state that automatic product dispatch of a loader is off or automatic product dispatch of a common port is off, acquiring icon position information of the machine of which the automatic product dispatch of the loader is off or the automatic product dispatch of the common port is off according to the product dispatch data;
the step of displaying a product dispatch status indicator at a position corresponding to an icon of the machine of which automatic product dispatch is off according to the icon position information of the machine of which automatic product dispatch is off comprises:
displaying the first product dispatch status indicator at a position corresponding to an icon of the machine according to the icon position information of the machine of which the automatic product dispatch of the loader is off or the automatic product dispatch of the common port is off.

7. The screen display control method of claim 5, wherein the product dispatch status indicator comprises a second product dispatch status indicator;
the step of obtaining an icon position information of a machine of which automatic product dispatch is off according to the product dispatch data of each machine comprises:
if it is determined according to the product dispatch data of the machine that the machine is in a state that automatic product dispatch of the unloader port is off, acquiring icon position information of the machine of which the automatic product dispatch of the unloader port is off according to the product dispatch data;
the step of displaying a product dispatch status indicator at a position corresponding to an icon of the machine of which automatic product dispatch is off according to the icon position information of the machine of which automatic product dispatch is off comprises:
displaying the second product dispatch status indicator at a position corresponding to an icon of the machine according to the icon position information of the machine of which the automatic product dispatch of the unloader port is off.

8. The screen display control method of claim 2, wherein a step of obtaining the product dispatch data comprises:
acquiring an automatic product dispatch instruction of a manufacturing execution system of a manufacturing enterprise; and
parsing the automatic product dispatch instruction to obtain the product dispatch data of each machine.

9. The screen display control method of claim 1, further comprising a step of: if it is determined according to the plurality of types of operating data of the machine that the machine is currently in a qualified batch sorting operation mode, displaying a qualified batch sorting indicator at a position corresponding to the icon of the machine.

10. The screen display control method of claim 1, wherein the operating data comprises piece loading data of each chamber of the machine, and the screen display control method further comprises:
when the machine is operating normally, if it is determined according to the piece loading data of each chamber of the machine that no piece is loaded within a preset time, displaying an abnormal idling indicator at a position corresponding to the icon of the machine.

11. The screen display control method of claim 1, further comprising:
if a query icon on the interface is triggered, displaying query menu options; wherein, the query menu options comprise one or more of an alarm list, equipment information, product in process list, workshop production management list, machine historical status information, idle equipment information, automatic product dispatch setting data of each machine, and machine product dispatch historical data.

12. The screen display control method of claim 1, further comprising:
obtaining an inventory quantity of a storage turnover warehouse according to the plurality of types of operating data of the machine; and
if the inventory quantity is greater than a preset full warehouse threshold, displaying a warehouse explosion early warning indicator.

13. The screen display control method of claim 1, further comprising:
obtaining an inventory quantity of a storage turnover warehouse according to the plurality of types of operating data of the machine; and
if the inventory quantity is less than a preset full warehouse threshold, displaying a storage space remaining indicator.

14. The screen display control method of claim 1, further comprising:
obtaining an inventory quantity of a storage turnover warehouse according to the plurality of types of operating data of the machine; and
if the inventory quantity is greater than a preset shutdown threshold, displaying a warehouse shutdown indicator.

15. The screen display control method of claim 13, wherein the obtaining an inventory quantity of a storage turnover warehouse according to the plurality of types of operating data of the machine comprises:
acquiring an order quantity allocated to the machine through an order production system;
acquiring a quantity of pieces that have already been loaded in the machine; and
obtaining the inventory quantity of the current storage turnover warehouse according to a difference between the allocated order quantity and the quantity of pieces already loaded.

16. The screen display control method of claim 1, further comprising:
acquiring photoresist data uploaded by each sensor on the production line, if it is determined according to the photoresist data that a photoresist of a corresponding machine is insufficient, displaying a photoresist insufficient indicator at a position corresponding to the icon of the machine.

17. A computer device, comprising a memory and a processor, the memory having a computer program stored therein, which, when executed by the processor, the following steps are implemented:
obtaining icon position information of a faulty machine and fault information of the faulty machine according to a plurality of types of operating data of each machine and a plurality of corresponding types of alarm thresholds, the fault information being configured to characterize a fault type of a fault that occurs in the faulty machine;
controlling an icon corresponding to the faulty machine on an interface to be displayed in accordance with a preset fault early warning state according to the icon position information of the faulty machine; and
displaying the fault information of the faulty machine when the icon of the faulty machine is triggered.

18. A computer readable storage medium, having a computer program stored thereon, which, when executed by the processor, the following steps are implemented:
obtaining icon position information of a faulty machine and fault information of the faulty machine according to a plurality of types of operating data of each machine and a plurality of corresponding types of alarm thresholds, the fault information being configured to characterize a fault type of a fault that occurs in the faulty machine;
controlling an icon corresponding to the faulty machine on an interface to be displayed in accordance with a preset fault early warning state according to the icon position information of the faulty machine; and
displaying the fault information of the faulty machine when the icon of the faulty machine is triggered.
